(19) United States
(12) Patent Application Publication
(10) Pub. No.: US 2003/0202462 A1
(43) Pub. Date: Oct. 30, 2003

(54) Method and apparatus for fail over protection in a voice over internet communication system

(76) Inventors: David B. Smith, Hinsdale, IL (US); Matthew R. Smith, Hinsdale, IL (US); George Paul Wilkin, Bolingbrook, IL (US)

Correspondence Address: Patent Docket Clerk, Jenner & Block LLC, One IBM Plaza, Chicago, IL, 60611, US

(21) Appl. No.: 10/134,963

(22) Filed: Apr. 29, 2002

(51) Int. Cl. H04J 1/16; H04L 12/66

(52) U.S. Cl. 370/216; 370/352

(57) ABSTRACT

In a packet data communications system (100) that supports VoIP communications via cable modem, a fail over detector (200) identifies trouble (eq, no dial tone, delayed dial tone, low quality of service, no voltage, no current, network busy) on or within the communications path. In response, voice communications are switched to a secondary path, such as, for example, the PSTN, or some other reliable and/or predictable communications network, thereby insuring uninterrupted voice communications.

### FIELD OF THE INVENTION

The present invention relates generally to telephony services, and in particular, to a method and apparatus that provides fail over protection for voice over Internet protocol (VoIP) telephone services.

### BACKGROUND OF THE INVENTION

Voice over Internet protocol (VOIP) telephone services are known. Such systems allow voice calls using Internet Protocol (“IP”) networks such as the Internet as an alternative to traditional public switched telephone networks (“PSTN”). Unlike the PSTN, which is circuit-switched, the Internet is packet-switched. As such, communications on the Internet is accomplished by transmitting and receiving packets of data. In addition to data, each packet contains a destination address to ensure that it is routed correctly. The format of these packets is defined by the IP. One type of allowable data is encoded, digitized voice, termed voice over IP (VoIP). VoIP is voice that is packetized as defined by IP, and communicated over the Internet for telephone-like communication. Individual VoIP packets may travel over different network paths to reach the final destination where the packets are reassembled in correct sequence to reconstruct the voice information.

While transmission over the Internet may be inexpensive relative to transmission over the PSTN, the Internet exhibits communication challenges that are not present in the PSTN. By way of example, and not by way of limitation, the transmission speed between any two Internet users can change drastically due to the dynamic number of users sharing the common transmission medium, their bandwidth requirements, the capacity of the transmission medium, and the efficiency of the network routing and design. Other challenges associated with VoIP service provision include the variability of the quality of the signal received at the destination (i.e., the number of transmission errors such as packet loss, packet delay, corrupted packets, etc.).

Thus, while the Internet may be a suitable medium for voice communications, transmission quality is not guaranteed, which in turn, may result in inconsistent performance. While such inconsistent performance may be tolerable for purposes of data transmission, it will in general be intolerable for voice communications, and in particular be unacceptable when the call in question is of an emergency nature, such as, for example, a call to an emergency response team, or a call to a 911 dispatcher.

Accordingly, there exists a need for a customer premise device to make reliable calls when the quality of service (QoS) for a particular call is unacceptable.

### SUMMARY OF THE INVENTION

The need is met and an advance in the art is made by the present invention, which provides a customer premise device with access to a reliable network when quality of service for a VoIP connection is unacceptable.

In accordance with one aspect of the present invention a fail-over detector monitors the communications path of a communications network providing VoIP services. Based upon various performance characteristics and availability of a connection, the detector selects between a predictable (e.g., plain old telephone connection) and unpredictable (eg, cable-based Internet connection) communications network for use by a system subscriber for purposes of voice communication. In accordance with another aspect of the invention, the fail-over detector employs a digital signal processor (DSP) to process an input signal consisting of voice, data, video, and/or combinations thereof. A fail-over detector monitors a DSP output. Based upon various performance characteristics or availability of a connection, the detector selects between a predictable and unpredictable communications network for use by a system subscriber for purposes of voice communication.

In accordance with another aspect of the invention, the fail-over detector is disposed within an Enhanced Multimedia Terminal Adapter (EMTA) such as, for example, a cable television modem.

In another aspect of the invention, a method is provided for establishing fail over contingency. The method begins with the monitoring of a first (unpredictable) communications path for a set of performance characteristics such as, for example, voltage, current, impedance, clock signals, open circuits, and the like. The first communications path supports VoIP service provision. Upon detection of a fault condition, a second (predictable) communications path is used for the provision of voice communications.

### BRIEF DESCRIPTION OF THE DRAWINGS

FIG. 1 is a block diagram of a multimedia communications system that provides voice over Internet protocol (VoIP) telephone services in accordance with the present invention; and

FIG. 2 is a block diagram of a fail over detector in accordance with the present invention.

### DESCRIPTION OF THE PREFERRED EMBODIMENTS

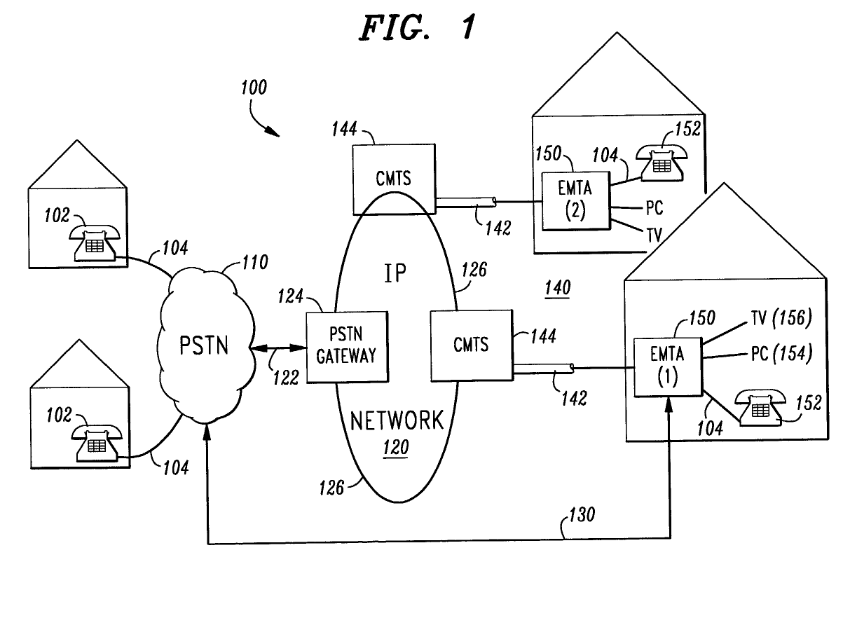

FIG. 1 is a block diagram of a multimedia communications system 100 that provides voice over Internet protocol (VoIP) telephone services. Multimedia communications system 100 includes, in part, a cable modem network 140 providing VoIP service, an Internet Protocol (IP) network 120 providing packet switched communications, and a public switched telephone network (PSTN) providing plain old telephone services (POTS). User terminals 102, 152 are typically telephone devices or modems that utilize well-known analog circuit switched protocols to couple to the communications system 100 and to transmit and receive data over subscriber lines 104, comprised in part, of twisted wire pairs.

With reference to FIG. 1, a cable modem network 140 includes user terminals 152 coupled to enhanced multimedia terminal adapters (EMTA) 150. In the past, EMTA equipment, frequently referred to as a cable modem or a set top box, has been available by contacting a local cable television service provider, such as, for example, AT&T Broadband. EMTA 150 is designed to receive an input and, in response, direct an appropriate output to one or more peripheral devices, such as terminal 152, personal computer 154 (not shown), or television 156 (not shown). For example, EMTA 150 directs Internet data, such as Web pages, to PC 154; Internet voice data is directed to terminal 152; and cable TV signals are directed to TV 156. As shown in FIG. 1, each EMTA 150 is coupled to a cable modem termination switch (CMTS) 144 via a communications link 142. In accordance with a preferred embodiment, the communications link 142 is a coaxial cable, or the like.

Each CMTS 144 is coupled together by means of a data network. In accordance with a preferred embodiment, the data network consists of IP network 120, which may be the Internet (e.g., the World-Wide Web) or a dedicated intranet that employs IP routing techniques. As such, each CMTS 144 is shown coupled, one to the other, via data links 126. As will be appreciated, such data links implement known packet-based protocols well within the knowledge of those skilled in the art.

With further reference to FIG. 1, IP network 120 is shown coupled to PSTN gateway 124 via previously discussed data links 126. PSTN gateway 124 is in turn coupled to PSTN 110 via communications link 122. During operation, PSTN gateway 124 converts circuit-switched communications received from PSTN 110 to a packet data protocol acceptable to the IP network 120. Conversely, PSTN gateway 124 converts packet data received from IP network 120 to a circuit-switched protocol acceptable to PSTN 110. PSTN gateway 124, data link 126, and communications link 122 provide an interface for user terminal 102. By virtue of this connection, a user terminal 102 is coupled to elements attached to the PSTN 110 and elements attached to the IP network 120, such as a telephone 152 connected to EMTA 150.

In a similar fashion, CMTS 144 converts data received from EMTA 150 to a data protocol acceptable to the IP network 120. Conversely, CMTS 144 converts data received from IP network 120 to a protocol acceptable to EMTA 150. CMTS 144, data link 126, and communications link 142 provide an interface for user terminal 152. By virtue of this connection, user terminal 152 is coupled to elements attached to the IP network 120, such as a telephone 102 connected to PSTN 110. In addition, user terminal 152 may couple to elements attached to the IP network 120, such as a telephone 152 connected to another EMTA 150. As will be appreciated after review hereof, a call placed between two user terminals 152 supports the provision of VoIP telephone services in accordance with the present invention.

As anticipated, communication over IP network 120 may, in several instances, be less expensive than communication over PSTN 110. For example, when EMTA 1 and EMTA 2 of FIG. 1 are separated by large geographic distances, communications over IP network 120 will generally avoid the long distance rate charges typically associated with placing a similar call over the PSTN 110.

Despite the potential cost advantage, IP network 120, nevertheless exhibits performance characteristics that are not present in the PSTN 110. First, IP Network 120, like all IP-based communications systems is an unpredictable communications system. Unlike the PSTN 110, IP network 120 uses shared, rather than dedicated resources to connect a call. This sharing tends to make IP network 120 less likely to achieve a connection path, and therefore unpredictable. In addition, the transmission speed between any two IP network 120 users can change drastically due to the dynamic number of users sharing the common transmission medium, the dynamic bandwidth requirements, the capacity of the transmission medium, and the efficiency of the network routing and design. Other deleterious performance characteristics include variability in the quality of the received signal due to transmission errors, lost packets, packet delay, corrupted packets, and the like. Thus, while the Internet may be a suitable medium for voice communications the suitability is not very consistent. Such inconsistency is completely intolerable when the call in question is of emergency status, such as, for example, a call to an emergency response team, or a call to a local 911 dispatcher.

With further reference to FIG. 1, EMTA (1) is shown coupled to PSTN 110 via a communications link 130. In accordance with a preferred embodiment of the present invention, the communications link 130 supports any of a number of reliable communications protocols including, but not limited to POTS, Ethernet, Integrated Services Digital Network (ISDN), Digital Subscriber Line (DSL), RF packet data, IEEE-802.11, Time Division Multiplex (TDM), Code Division Multiplex (CDM), Global System Mobile (GSM) and the like. As will be appreciated, after careful consideration of the invention disclosed herein, the communications link 130 affords the cable network 140, or any similarly situated communications system providing VoIP services, fail-over protection in the instance that a VoIP call is beset by the unpredictable nature of IP network 120. In that instance, EMTA (1) can elect to send a call via a predictable, as opposed to the unpredictable communications network. Such fail over protection greatly enhances the marketability of VoIP systems as they continue to compete with the PSTN 110 and other predictable communication networks.

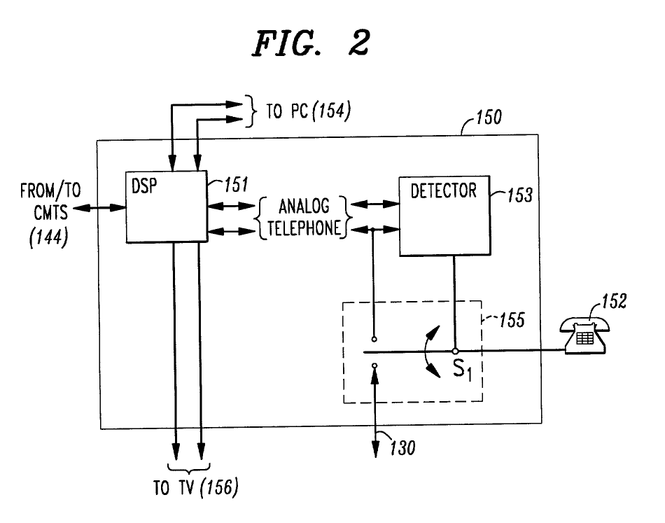

FIG. 2 is a block diagram of a fail over detector in accordance with the present invention. As shown, the detector 153 is disposed within EMTA 150. In accordance with a preferred embodiment, detector 153 may be any of a number of detectors designed to monitor various performance characteristics of a signal in question. In accordance with the present invention, detector 153 may be a voltage detector, current detector, line detector, tone detector, clock signal detector, open circuit detector, and the like. Its primary function is to monitor the output from digital signal processor (DSP) 151 that is destined for terminal 152. As shown, the signal in question is an analog telephone signal, as known in the art.

By monitoring the analog telephone signal, detector 153 provides an indication of the current status of the communications path comprised of IP network 120. Since IP network 120 is somewhat unpredictable, service disruptions and/or anomalies may be detected by detector 153 as a function of voltage, current, and/or impedance level, or the presence or absence of clock or tone within the analog telephone signal generated by DSP 151.

During operation, DSP 151 receives an input signal from CMTS 144. As will be appreciated, this input may comprise a multimedia content consisting of voice, data, video, or combinations thereof. DSP 151 processes the input and generates separate and distinct outputs as depicted in FIG.2.

Detector 153 controls the operation of switch S1. Under normal operating conditions switch SI connects terminal 152 to the analog telephone output from DSP 151. Upon detection of a service disruption/anomaly, detector 153 causes switch S1 to connect terminal 152 to communications link 130 for purposes of voice communications. As previously discussed, communications link 130 is coupled to a reliable communications network. As such, voice communications within the otherwise unpredictable system defined by IP network 120 can now be assured by the access to a reliable communications path.

In accordance with one embodiment of the present invention, communications via the reliable communications path sourced by communications link 130 is reserved for voice calls, only. In accordance with another embodiment of the present invention, communications via the reliable communications path is reserved for emergency calls, only. In yet another embodiment of the present invention, communications via IP network 120 is reestablished once a service disruption is no longer detected by detector 153.

In an alternate embodiment of the invention, detector 153, in conjunction with DSP 151, causes switch S1 to connect terminal 152 to communications link 130 (a reliable communications network), if a call setup procedure through CMTS 144 and IP network 120 is unsuccessful. For example, if no dial tone is received or is delayed at initiation of a call by terminal 152, DSP 151 and detector 153 sense this condition and cause switch S1 to connect terminal 152 to communications link 130. Other conditions that may cause a switch to a predictable network during call setup include network busy or an analytic measure of quality of service below an acceptable threshold. If a switching condition is sensed after terminal 152 has dialed digits identifying the called party, DSP 151 repeats those digits after a switch to communications link 130 in a manner consistent with the protocol expected by communications link 130 and its interface to the PSTN. Preferably, call setup sensing and protocol are accomplished by DSP 151 in conjunction with a stored program to implement the functions.

In additional embodiments, a physical switch is provided for a user to select the network for a call. For example, a physical switch may be added to EMTA 150 to force switch Si to a desirable setting. A physical switch may also defeat, that is prevent, or enable, a fail over option as described above, including a selection of the criteria for the fail over option.

Whereas the present invention has been described with respect to specific embodiments thereof, it will be understood that various changes and modifications will be suggested to one skilled in the art and it is intended that the invention encompass such changes and modifications as fall within the scope of the appended claims.

1. A fail over detector comprising:
a detector, coupled to a first communications path offering VoIP service provision and exhibiting performance characteristics; and
a switch, coupled to the detector and a user terminal, for selecting one of the first communications path and a second communications path, as a function of the performance characteristics exhibited by the first communications path.

2. The fail over detector of claim 1, further comprising a cable modem coupled to the first communications path.

3. The fail over detector of claim 2, further comprising a digital signal processor (DSP), coupled to the detector, to receive an input.

4. The fail over detector of claim 1, wherein the first communications path employs an IP communications protocol.

5. The fail over detector of claim 1, wherein the second communications path supports one of a plurality of communications protocols selected from the Group consisting of: Pots, Ethernet, ISDN, DSL, RF packet data, IEEE-802.11, TDM, CDM, GSM.

6. The fail over detector of claim 1, wherein the second communications path comprises a predictable communications network.

7. The fail over detector of claim 3, wherein the detector is disposed within an enhanced multimedia terminal adapter.

8. The fail over detector of claim 1, wherein the performance characteristics exhibited by the first communications path are selected from a group consisting of: voltage, current, impedance, delay, dial tone, network busy and audible tones.

9. The fail over detector of claim 7, wherein the detector is selected from a group consisting of: voltage detectors, current detectors, line detectors, tone detectors, clock signal detectors, and open circuit detectors.

10. In a packet data communication system providing VoIP services, a fail over detector comprising:
a digital signal processor, coupled to a first communications path, to process an input signal, the first communications path exhibiting a plurality of performance characteristics and supporting provision of VoIP services;
a detector, coupled to the digital signal processor, to monitor at least one of the performance characteristics exhibited by the first communications path; and
a switch, coupled to the detector and operably coupled to a user terminal, for switching the user terminal between the first communications path and a second communications path, as a function of the at least one performance characteristics exhibited by the first communications paths.

11. The apparatus of claim 10, wherein the input signal comprises at least one of voice, data, and video.

12. The apparatus of claim 10, wherein the at least one performance characteristics exhibited by the first communications network includes a performance characteristic that is monitored in conjunction with call setup.

13. The apparatus of claim 10, wherein the second communications path supports one of a plurality of communications protocols selected from the group consisting of: POTS, Ethernet, ISDN, DSL, RF packet data, IEEE-802.11, TDM, CDM, GSM.

14. The apparatus of claim 10, wherein the detector is disposed within an enhanced multimedia terminal adapter (EMTA).

15. The apparatus of claim 10, wherein the performance characteristics exhibited by the first communications paths are selected from a group consisting of: voltage, current, impedance, clock signals, delay, dial tone, network busy and audible tones.

16. The apparatus of claim 10, wherein the detector is selected from a group consisting of: voltage detectors, current detectors, line detectors, tone detectors, signal detectors, and open circuit detectors.

17. The apparatus of claim 10, further comprising a cable modem coupled to the first communications path.

18. A method for fail over contingency in a packet data communications system providing VoIP services comprising the steps of:
monitoring a first communications path offering VoIP services, for a set of performance characteristics; and
upon fault detection, selecting a predictable communications path for provision of voice communications.

19. The method claim 18 wherein the step of monitoring the first communications path further comprises the step of:
detecting a performance characteristic consisting of at least one of voltage, current, impedance, clock signals, and tone.

20. The method claim 18 wherein the step of selecting a predictable communications path for provision of voice communications further comprises the step of:
connecting a user terminal to a communications link using a communications protocol selected from a group consisting of:
POTS, Ethernet, ISDN, DSL, RF packet data, IEEE-802.11, TDM, CDM, GSM.
